(19) United States
(12) Patent Application Publication
(10) Pub. No.: US 2021/0049385 A1
(43) Pub. Date: Feb. 18, 2021

(54) SECURITY FEATURES USING VEHICLE PERSONALIZATION

(71) Applicant: GM GLOBAL TECHNOLOGY OPERATIONS LLC, Detroit, MI (US)

(72) Inventors: Nicholas W. Pinto, Shelby Township, MI (US); Kausalya Singuru, Troy, MI (US); Shiming Duan, Ann Arbor, MI (US); Yasen Hu, Warren, MI (US); Yao Hu, Sterling Heights, MI (US); Bradley R. Frieberg, Farmington Hills, MI (US); Gary L. Jones, Farmington Hills, MI (US); Thomas M. Forest, Macomb, MI (US)

(21) Appl. No.: 16/542,903

(22) Filed: Aug. 16, 2019

(51) Int. Cl. G06K 9/00; B60W 40/08; B60R 16/037; B60R 25/31; B60R 25/30; B60R 25/04

(52) U.S. Cl. CPC G06K 9/00832; B60W 40/08; B60R 16/037; G06K 9/00791; B60W 2040/0809; B60R 25/31; B60R 25/305; B60R 25/04; G06K 9/00362

(57) ABSTRACT

A system and method for personalization of security features of a vehicle. The system includes a memory having computer readable instructions and one or more processors for executing the computer readable instructions, the computer readable instructions controlling the one or more processors to perform operations. The operations include detecting a person in a cabin of a vehicle. At least one adjustable vehicle setting is detected in relation to the person in the cabin of the vehicle. The adjustable vehicle setting is compared to a stored adjustable vehicle setting in a first user profile. Operation of the vehicle by the person in the cabin of the vehicle is enabled based on the comparison and a permitted level of access from the first user profile.

### INTRODUCTION

The present disclosure relates to vehicle security, and more particularly relates to security settings using vehicle personalization.

In modern society, drivers and passengers utilize multiple vehicles in their day to day lives. These vehicles include personally owned, ride-sharing, and rental vehicles. People desire to control access and operability of vehicles based on possession regardless of the ownership of the vehicle. Therefore, it is desirable to enable vehicles to employ a transferable system that commands the functionality of the vehicle and permits a current operator to control access to and functionality of the vehicle.

### SUMMARY

In one exemplary embodiment, a method for personalizing security features is shown. A person is detected in a cabin of a vehicle. At least one adjustable vehicle setting in relation to the person in the cabin of the vehicle is also detected. The adjustable vehicle setting is compared to a stored adjustable vehicle setting in a first user profile. Operation of the vehicle is enabled based on the comparison and a permitted level of access from the first user profile.

In addition to the one or more features described herein, the adjustable vehicle setting includes one of a seat setting, a rear-view mirror setting, or a side-view mirror setting.

In addition to the one or more features described herein, the method further includes receiving a first characteristic identifying a person approaching the vehicle. The first characteristic is compared to a characteristic in a second user profile. A permitted level of access for the person approaching the vehicle is determined based on the comparison.

In addition to the one or more features described herein, when the comparison determines that the person approaching the vehicle is not the person identified by the second user profile, the method further includes requesting the person approaching the vehicle provide a second characteristic. The second characteristic is compared to a second stored characteristic in the second user profile. Access to the vehicle by the person approaching the vehicle is enabled based on the comparison of the second characteristic and the second stored characteristic.

In addition to the one or more features described herein, the method further includes detecting the vehicle accelerate at a rate greater than a threshold amount. An image of the person approaching the vehicle prior to acceleration is compared to images received from a law enforcement database. Law enforcement is contacted based on matching the image of the person accessing the vehicle to an image from the law enforcement database.

In addition to the one or more features described herein, the method includes prompting a driver of the vehicle to park the vehicle within a predetermined time period. The vehicle is in the event that the driver continues to drive longer than the predetermined time period.

In addition to the one or more features described herein, the method further includes prompting a driver of the vehicle to park the vehicle within a predetermined time period. The driver is prompted to answer a safety question upon detecting the vehicle parked within the predetermined time period.

In another exemplary embodiment, a system for personalizing security features includes a memory having computer readable instructions and one or more processors for executing the computer readable instructions, the computer readable instructions controlling the one or more processors to perform operations. The operations include detecting a person in a cabin of a vehicle. At least one adjustable vehicle setting is detected in relation to the person in the cabin of the vehicle. The adjustable vehicle setting is compared to a stored adjustable vehicle setting in a first user profile. Operation of the vehicle is enabled based on the comparison and a permitted level of access of the person in the cabin of the vehicle from the first user profile.

In addition to the one or more features described herein, the adjustable vehicle setting includes one of a seat setting, a rear-view mirror setting, or a side-view mirror setting.

In addition to the one or more features described herein, the operations further include receiving a first characteristic identifying a person approaching the vehicle. The first characteristic is compared to a characteristic in a second user profile. A permitted level of access of the person approaching the vehicle is determined based on the second user profile.

In addition to the one or more features described herein, when the comparison determines that the person approaching the vehicle is not the person identified by the second user profile, the operations further include requesting the person approaching the vehicle provide a second characteristic. The second characteristic is compared to a second stored characteristic the second user profile. Access to the vehicle by the person approaching the vehicle is enabled based on the comparison of the second characteristic and the second stored characteristic.

In addition to the one or more features described herein, the operations further include detecting the vehicle accelerate at a rate greater than a threshold amount. An image of the person approaching the vehicle prior to acceleration is received and compared the image to images received from a law enforcement database. Law enforcement is contacted based on matching the image of the person accessing the vehicle to an image from the law enforcement database.

In addition to the one or more features described herein, the operations further include detecting an unauthorized person in the vehicle. A driver of the vehicle is prompted to park the vehicle within a predetermined time period. The vehicle is disabled in the event that the driver continues to drive longer than the predetermined time period.

In addition to the one or more features described herein, the operations further include prompting a driver of the vehicle to park the vehicle within a predetermined time period. The driver is prompted to answer a safety question upon detecting the vehicle parked within the predetermined time period.

In another exemplary embodiment, a computer program product for personalizing security features includes a computer readable storage medium having program instructions embodied therein, the program instructions are executable by a processor to cause the processor to perform operations including detecting a person in a cabin of a vehicle. An adjustable vehicle setting is detected in relation to the person in the cabin of the vehicle. The adjustable vehicle setting is compared to a stored adjustable vehicle setting in a first user profile. Operation of the vehicle is enabled based on the comparison and a permitted level of access from the first user profile.

In addition to the one or more features described herein, the adjustable vehicle setting includes one of a seat setting, a rear-view mirror setting, or a side-view mirror setting.

In addition to the one or more features described herein, the operations further include receiving a first characteristic identifying a person approaching the vehicle. The first characteristic is compared to a first stored characteristic in a second user profile. A permitted level of access of the person approaching the vehicle is determined based on the comparison.

In addition to the one or more features described herein, when the comparison determines that the person approaching the vehicle is not the person identified by the second user profile, the operations further include requesting the person approaching the vehicle provide a second characteristic. The second characteristic is compared to a second stored characteristic the second user profile. Access to the vehicle by the person approaching the vehicle is enabled based on the comparison of the second characteristic and the second stored characteristic.

In addition to the one or more features described herein, the operations further include detecting the vehicle accelerate at a rate greater than a threshold amount. An image of the person approaching the vehicle prior to acceleration is received and compared the image to images received from a law enforcement database. Law enforcement is contacted based on matching the image of the person accessing the vehicle to an image from the law enforcement database.

In addition to the one or more features described herein, the operations further include detecting an unauthorized person in the vehicle. A driver of the vehicle is prompted to park the vehicle within a predetermined time period. The vehicle is disabled in the event that the driver continues to drive longer than the predetermined time period.

The above features and advantages, and other features and advantages of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 depicts a vehicle according to one or more embodiments described herein;

FIG. 2 depicts a flow diagram of a method for initializing security settings on a vehicle;

FIG. 3 depicts a flow diagram of a method for executing security settings on a vehicle; and

FIG. 4 depicts a block diagram of a processing system for implementing the techniques described herein according to an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The technical solutions described herein provide for vehicle security settings using personalization. In particular, the present techniques provide for the generating of a transferable user profile that enables a vehicle to dynamically react to data generated from different sensors (i.e., cameras, radar sensors, LiDAR sensors, etc.) associated with a vehicle. The individual user profiles are created and modified by administrators and include identifying characteristics of individuals and permitted levels of access to the vehicle. The user profiles are stored in a remote database in operable communication with the vehicle. Furthermore, the user profiles are associated with individuals and not a vehicle. Therefore, the user profiles can be used in conjunction with any vehicle.

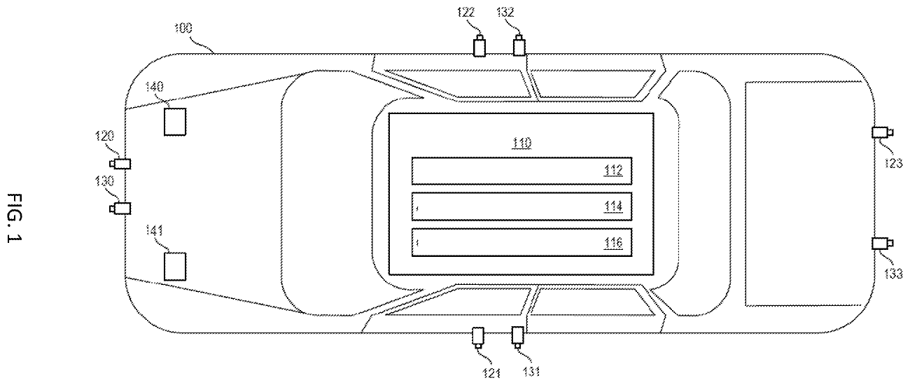

FIG. 1 depicts a vehicle 100 including sensors and a processing system 110 for multi-sensor multi-object tracking according to one or more embodiments described herein. The sensors include cameras 120, 121, 122, 123, cameras 130, 131, 132, 133, a radar sensor 140, and a LiDAR sensor 141. The vehicle 100 may be a car, truck, van, bus, motorcycle, boat, or another suitable vehicle 100.

The cameras 120-123 are surround view cameras that capture images external to, and in near proximity to, the vehicle 100. The images captured by the cameras 120-123 together form a surround view (sometimes referred to as a “top-down view” or a “bird's eye view”) of the vehicle 100. These images can be useful for operating the vehicle (e.g., parking, backing, etc.) and identification of individuals accessing the vehicle. The cameras 130-133 are long-range cameras that capture images external to and farther away from the vehicle 100 than images from the cameras 120-123. These images can be useful for object detection and avoidance, for example. It should be appreciated that, although eight cameras 120-123 and 130-133 are shown, more or fewer cameras may be implemented in various embodiments.

Captured images can be displayed on a display (not shown) to provide external views of the vehicle 100 to the driver/operator of the vehicle. The captured images can be displayed as live images, still images, or some combination thereof. In some examples, the images can be combined to form a composite view, such as the surround view. In some embodiments, the images are transmitted to a secondary location for processing.

The radar sensor 140 measures range to a target object by transmitting electromagnetic waves and measuring the reflected waves with a sensor. This information is useful for determining a large object's distance/location relative to the vehicle 100.

The LiDAR (light detection and ranging) sensor 141 measures distance to a target object by illumining the target with pulsed laser light and measuring the reflected pulses with a sensor. This information is useful for determining a target object's distance/location relative to the vehicle 100.

Data generated from the cameras 120-123,130-133, the radar sensor 140, and/or the LiDAR sensor 141 can be used to track a target object relative to the vehicle 100. Examples of target objects include other vehicles, pedestrians, bicycles, animals, and the like.

The processing system 110 includes and utilizes a detection engine 112, an association engine 114, and a control engine 116. Although not shown, the processing system 110 can include other components, engines, modules, etc., such as a processor (e.g., a central processing unit, a graphics processing unit, a microprocessor, etc.), a memory (e.g., a random-access memory, a read-only memory, etc.), data store (e.g., a solid state drive, a hard disk drive, etc.) and the like. The features and functionality of the components of the processing system 110 are described further herein.

In addition to the exterior sensors, the vehicle 100 is equipped with multiple sensors (not shown) within the cabin. The interior sensors include but are not limited to a camera, fingerprint scanner, heart rate monitor, voice recognition, and other biometric scanners. The interior sensors are configured to gather sensing data from the vehicle occupants and transmit the data from the interior sensor to the processing system 110 and a remote system (not shown).

The processing system 110 is configured to enforce access to a vehicle and its features based on user profiles. A user profile can be communicated to a vehicle, for example, a user's own vehicle, or communicated to another vehicle. The user profile not only governs the authorization of the user, but other individuals as well. For example, a vehicle owner's user profile can be configured to restrict access to other individuals. This security restriction can be implemented regardless of whether a user is occupying the vehicle. The vehicle owner's user profile can also be configured to conditionally restrict the authorization of other individuals. For example, a passenger's ability to change a temperature within a specified range or a child's authority to drive during certain hours. The rights can also be conditional upon an identity of an individual, an action, for example, an individual only has access upon receipt from educational software that schoolwork has been completed or from a medical-based application that specified health parameters have overcome a predetermined threshold. The vehicle rights for each individual are additionally stored in respective user profiles in the remote system, which is enabled to access the processing system 110 to enable or disable vehicle features pursuant to the enumerated rights.

Although the user profiles may have been established in reference to one vehicle, the profiles are usable with other vehicles. Periodically, users will rent vehicles or participate in ride-sharing services. In some embodiments, a third party, for example, a rental car or ride-sharing agency, contacts the remote database through a software application and the remote database shares the security settings with the third party. The identification of the driver and passengers can be provided to the remote system by the third party. For example, when a user contacts a ride-sharing service and connects with a driver, the user's computing device is alerted to contact the remote system. The remote system receives vehicle information from the ride-sharing service and the user profile is transmitted directly to the ride-sharing vehicle. In some embodiments, upon detecting that the vehicle is part of a ride serving service, the remote system modifies the user profile to a default user profile, which prevents a passenger of a ride-sharing service driver from controlling operation of the vehicle. The default user profile will restrict operability of a vehicle's driving functions, but will provide adjustments of vehicles features desirable by the user, such as car seat features. In addition, the default user profile would transmit suggestions (i.e., temperature, music, windows, etc.) to the driver's mobile device or on-board computer.

In other instances, a rental vehicle or ride-sharing vehicle is equipped with sensors that are operable to capture biometric data of a person approaching the vehicle. Upon capturing the biometric data, the vehicle transmits the information to a remote system to determine a match with a user profile. If a match is determined, the remote system transmits the user profile to enter the vehicle.

The user profile is not exclusive to a particular vehicle. However, the user profile does include information regarding any adjustable features associated with the user, and the year, make and model of the vehicle that was used to take the measurements. The adjustable features include any personalized feature available in a vehicle. In some embodiments, a vehicle code or number is used to access a list of vehicle measurement information. The list includes standard measurements of a vehicle, for example, a seat height, a seat depth, a gear shift position, etc.

Using the vehicle's identification, a processor translates the measurements taken from the original vehicle to conform to measurements of a new vehicle. For example, if the seat measurements were taken in a sedan, the processor applies a respective translation factor to each seat measurement to convert the measurements to comparable measurements for a seat of a truck. In other embodiments, the processor has access to a look-up table (LUT) which provides a measurement of adjustable features of a new vehicle that correspond to a measurement for the original vehicle. Therefore, if seat adjustment measurements were taken in a sedan, the processing system can determine whether a user has positioned the seat similarly in a truck.

For example, a processing system detects adjustments a driver/passenger makes in a rented sports utility vehicle (SUV) or newly purchased SUV and transmits those measurements to the remote database. A processor at the remote database receives those measurements and compares them to measurements stored in the user's profile. The processor additionally receives a vehicle identification of the SUV and compares the SUV's vehicle measurements with the original vehicle. If the original vehicle and the SUV are similar vehicles, the processor compares any adjustments (i.e., seat adjustments, driving patterns, mirror alignments, etc.) with the measurements stored in the user profile. If, however, the positioning of adjustable features of the second vehicle is different than the original vehicle, the processing system adjusts the measurements from the original vehicle to conform to the second vehicle and determines whether the user has positioned the adjustable feature similar to the original vehicle. For example, the seat of a truck is expected to be higher than in a convertible. In this instance, if the measurements were originally taken in a convertible style vehicle, the processing system adjusts the measurements to conform to the higher seat of a truck. The processing system then determines whether the driver/passenger has adjusted the seat of the truck in conformity with how a seat was adjusted in the convertible. A driver/passenger's seat adjustment that does not match the seat measurements in the intended user's profile is an indication that the user profile belongs to someone other than the driver/passenger. In this instance, the processing system can disable operability of the vehicle, the adjustable features, or both.

It should be appreciated that vehicles do not uniformly possess the same sensing capabilities. For example, a luxury version is expected to have greater sensing capabilities than a base model. A minivan is expected to have greater sensing capabilities than a coupe. Additionally, a vehicle sensor may become damaged or blocked. In each case, the determination of an identity of a person accessing the vehicle still needs to be performed. Each sensed characteristic (for example, an image, heart rate, fingerprint, etc.) is provided a score, based on the characteristic and an accuracy of the information provided by the sensor. An image is expected to have a greater characteristic score than a heart rate. This is due to an image being a more reliable source of identification than a heart rate. The sensor score also provides information as to the level of accuracy of an identification based on the sensed characteristics. For example, if a fingerprint is less than a threshold point match, the sensor score for accuracy is reduced. In another example, if an image is partially obstructed, the sensor score for accuracy is reduced. Each characteristic and accuracy score are additionally weighted based on the characteristics and accuracy. The sensor scores are combined to calculate an overall score. An overall score is based on the respective sensed characteristics used to make the identification. Each user profile includes a list of acceptable and unacceptable characteristics and threshold amounts.

A threshold for determining identification varies based upon the available sensors. As suggested above, a luxury vehicle is expected to have greater sensing capabilities than a base model. In this situation, the threshold value for making a determination of identity is lower for the base model than the luxury model due to the base model's lower sensing capabilities. The threshold is also adjustable based on the available sensors, a value of the vehicle, or user-initiated settings.

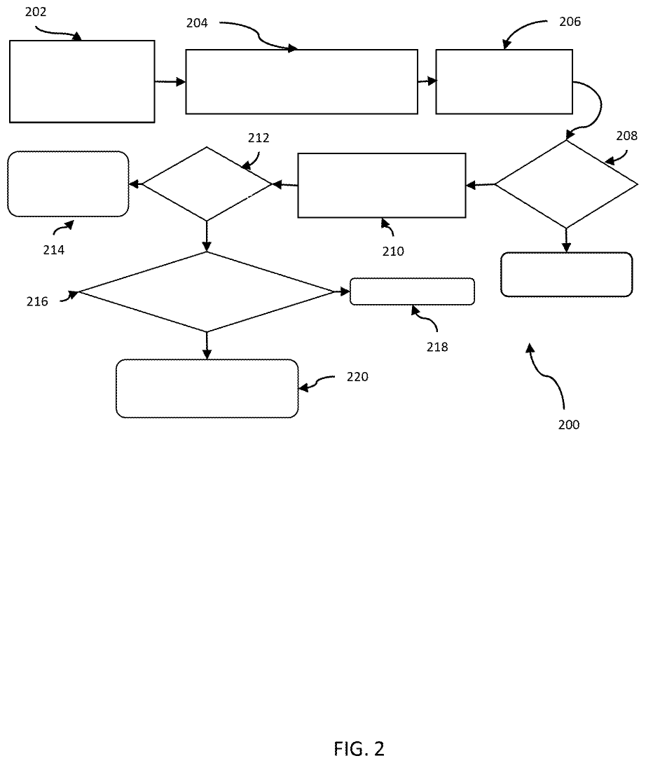

Referring to FIG. 2, a method 200 for initially creating a user profile and setting security settings or to subsequently update the settings is shown. At block 202, a user creates a profile by either manually entering information through a software application or providing a premade user profile. In instances in which the user has previously created a profile, the user transmits the user profile to either the processing system 110, a remote database, or both. The user profile includes identifying information including, but not limited to name, passcodes, image, and relation to the vehicle. In some embodiments, the user profile additionally includes a voice sample, fingerprint, heartbeat sample, or other biometric data. In some embodiments, upon the receipt of the user profile, a remote system accesses a user device or the internet to gather publicly available information to supplement the user profile. For example, if the user is transmitting data from a mobile electronic device, the remote system gathers information regarding most frequently visited websites in the user's browser history or particular social media or service applications associated with the user. In addition to information inputted by the user, the system gathers information from the vehicle regarding the user's vehicle setting preferences. For example, a seat height, an angle of a seat back, a distance of a seat from the pedals, a rear-view mirror alignment, a side-view mirror alignment, a driving mode, radio settings including volume, and HVAC settings.

At block 204, the user establishes vehicle rights for administrators and non-administrative users. The rights are based on a position of the user and restrict access to either the entire vehicle or select features of the vehicle. The user establishes which individuals are administrators and which are non-administrators. Administers have the ability to modify the security settings, whereas non-administrators cannot modify the settings. The non-administrators are either identified individuals or any individual that is not an administrator. At block 206 the user creates an emergency contacts list, which can include individuals known to the user and/or law enforcement/security contacts.

At block 208, the user chooses to enable the user profile with the security settings. In some embodiments, the security settings are continuously enabled until an administrator chooses to disable the settings. In other embodiments, the vehicle is equipped with sensors detecting available internet access. If the system detects no or weak internet access, it will automatically disable the security settings. This helps a user to fully operate the vehicle and deviate from user settings if necessary, without the necessity of modifying the security features.

At block 210, the processing system 110 senses a person approaching or accessing the car. At block 212, the remote system determines if the person is recognized based on a comparison of user profiles stored in the database and detected characteristics of the person. The vehicle is equipped to sense a person approaching the vehicle, for example, by sensing a mobile device signal, fob key signal, or through motion detection. Upon detecting the person, and processing system 110 initiates the sensors to detect characteristics of the person. For example, the processing system 110 compares the captured image with stored images of people to detect a match through image recognition software.

In addition to an initial verification, the vehicle is equipped to prompt the person to provide secondary information. The prompt can be delivered by internal or external speakers, or illuminated devices and provide audio or visual messages. For example, in some embodiments, the vehicle is equipped with an external biometric scanner and requires the person to provide biometric information, such as a fingerprint or voice sample. The remote system compares the biometric data with stored user profiles. If the biometric data matches, the remote system will send a signal to the processing system 110 to authorize access and load personalized settings at block 214. The processing system initially requests user profiles of individuals previously associated with the vehicle. Once a person is identified and the authority to access the vehicle has been verified, the vehicle's identification is stored in the user's profile.

If the person is not recognized, the remote system verifies with the user profiles associated with the vehicle as to whether an unrecognized person has permission to access the vehicle at block 216. If an unrecognized person does not have permission to access the vehicle, the remote system causes the processing system 110 to lock any doors and/or disable the ignition function and/or the propulsion system of the vehicle at block 218. If an unrecognized person does have permission to access the vehicle, the remote system causes the processing system 110 to enable the use of vehicle pursuant to any user-defined restrictions at block 220.

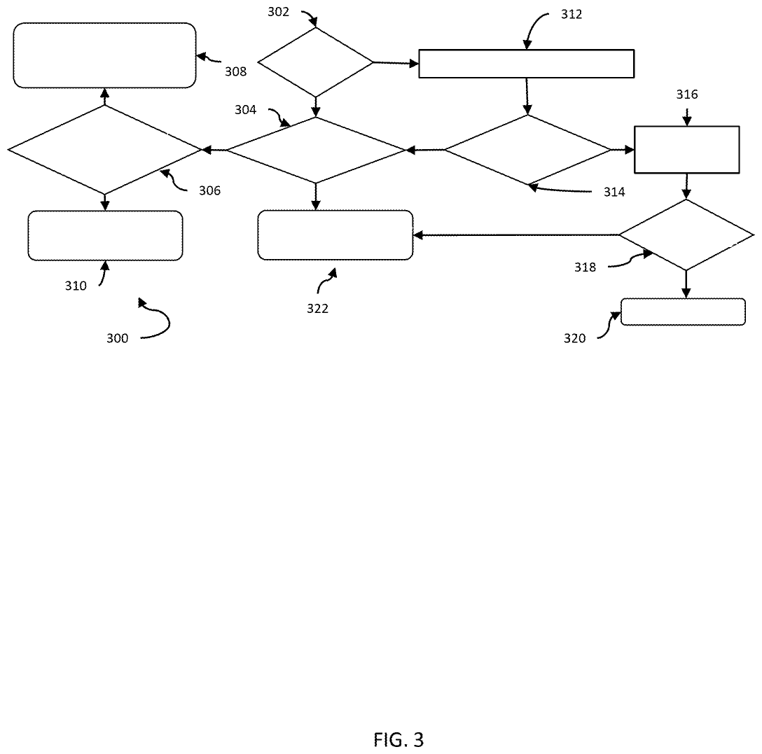

Referring to FIG. 3, a method 300 for accessing the vehicle is shown. At block 302, the processing system 110 senses a person approaching or accessing the vehicle and receives information for comparison of user profiles stored in the remote system. The processing system can be configured such that a signal from an electronic device used by the person alone conveys identification. In other embodiments, the vehicle is configured to use sensed data to confirm the identity of the person. For example, through image recognition techniques or other biometric indicators. At block 304, if the driver is identified, the processing confirms with the remote system as to whether the person has permission to access the vehicle 100. If a person has the authorization to access the vehicle, the processing system confirms with the remote system and grants access pursuant to predetermined settings at block 322. If a person does not have permission to access the vehicle, the processing system confirms with the remote system whether an unauthorized person has authority to access to the vehicle at block 306. If an unauthorized driver can access the vehicle, the processing system 110 allows access pursuant to predetermined settings at block 308. If an unauthorized driver does not have permission, the processing disables the vehicle 100 at block 310. In some embodiments, disabling the vehicle additionally causes the system to contact the owner and/or law enforcement. As described above, the owner has the ability to enable or disable the security settings. Therefore, the processing system 110 executes the security based on the level of enablement chosen by an administrator.

If the person was not recognized at block 302, the processing system causes the vehicle to request additional information at block 312. The request can be in the form of a text message sent to the person's phone, a mobile application, or voice through an on-board speaker. In some embodiments, certain sensors illuminate to draw the person's interest to the sensor.

In some embodiments, the vehicle is equipped with an external biometric scanner and require the person to provide a fingerprint or voice sample prior to a door being unlocked. In other embodiments, the remote system is configured to prompt the person to identify the most frequented websites by the user. In this instance, a bad actor posing as the authorized user would not have access to the user's current browser history and would not know this information. At block 314, the remote system determines whether the person is identified. If the person is not identified, the remote system contacts the owner or other administrator at block 316. At block 318, the remote system determines whether the owner has granted permission. If no permission is granted, the remote system causes either the door to lock and/or the vehicle to be disabled at block 320

If the person is not recognized, the remote system verifies whether an unrecognized person has permission to access the vehicle at block 318. If an unrecognized person does not have permission to access the vehicle, the remote system causes the door to be locked and/or disabling of the ignition function and/or the propulsion system of the vehicle at block 318. If an unrecognized person does have permission to access the vehicle, the remote system permits the use of the vehicle pursuant to any user-defined restrictions at block 322. Additionally, if the owner grants access manually or upon request, the remote system permits access at block 322.

In addition to actively prompting sensors to take readings and prompting a response from a person, the remote system also monitors the adjustable settings as an additional safety feature. For example, as an authorized user is driving, the processing system gathers data including, but not limited to temperature, driving routes, and seat adjustment settings. In an instance that a driver has been verified as an authorized user, the processing system 110 continues to cause sensors to gather data. If, for example, the user profile indicates that the driver is a particular height and the sensor are detecting that the seat settings or mirror settings do not conform to a person of that height, the remote system can cause the vehicle to issue a prompt for the driver to pull over, park, and reverify identity within a specified time period. If the driver chooses not to pull over the remote system can cause the vehicle to be disabled within a threshold time period. The security settings are modifiable such that the time period is adjustable. The remote system can cause the threshold time period to be reduced if the discrepancy is settings is coupled by erratic driving or driving a threshold amount over the speed limit as determined by readings from a global positioning satellite system.

The user settings can also be configured to match different vehicle types. Upon identification, the remote system causes the vehicle to adjust the vehicle features to the user's setting features. The remote system further includes translation factors that translate adjustable feature measurements from one type of vehicle to another type of vehicle. For example, if a user normally drives sedan and choose to drive a truck, the seat and mirror settings are adjusted using a translation factor to conform to settings to a truck. The remote system continuously compares the adjustable feature settings with the stored feature settings. If the user's stored settings do not match the adjusted settings, the remote system causes a prompt for renewed verification as described above.

The remote system is configured to monitor for occurrences that indicate that a vehicle should be disabled or that law enforcement should be notified. Based on tracking the vehicle through a global positioning system, the remote system determines if the vehicle has stopped, or decelerated/accelerated faster than a threshold amount. In these instances, the remote sensor retrieves visual data recorded by the camera preceding the stop or acceleration/deceleration and captures an image of any person in the vicinity of the vehicle. The remote system then compares the image of the person with stored image(s) and images from a law enforcement database. In some embodiments, the data is cloud-based and received from a law enforcement database. If the person is known and authorized to access the vehicle, the remote system commits to no further action. If, however, the remote system does not recognize the identity or the person is listed in a law enforcement database, the remote system contacts the owner or authorized driver for authorization for the unidentified to enter or remain in the vehicle. In some instances, the remote system immediately contacts law enforcement based on a level of severity of offenses associated with the person. In some embodiments, the vehicle is equipped with a heart rate monitor. If the heart rate increases above a threshold amount and this is coupled with the presence of a second person, the remote system causes a prompt to have the owner or authorized driver to confirm the permission of the second person to remain in the vehicle.

In some embodiments, the user settings include a safety code or answer. In the event that law enforcement is contacted, the safety code or answer is transmitted to law enforcement. An officer can ask the owner or authorized driver a question and verify whether the occupants of the vehicle are safe. In some embodiments, the safety code or answer are based on real-time occurrences. For example, the remote system can monitor where an individual was at a particular time prior to a safety event. In other embodiments, the remote system can access a user's electronic calendar and search for upcoming events. Therefore, the safety code or answer may be generated electronically in real-time and a bad actor would not have access to this information.

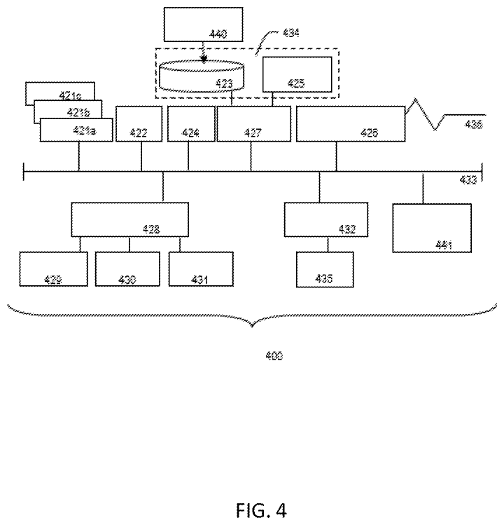

It is understood that the present disclosure is capable of being implemented in conjunction with any other type of computing environment now known or later developed. For example, FIG. 4 depicts a block diagram of a processing system 400 for implementing the techniques described herein. In this example, the processing system 400 has one or more central processing units (processors) 421a, 421b, 421c, etc. (collectively or generically referred to as processor(s) 421 and/or as processing device(s)). In aspects of the present disclosure, each processor 421 can include a reduced instruction set computer (RISC) microprocessor. Processors 421 are coupled to system memory (e.g., random access memory (RAM) 424) and various other components via a system bus 433. Read only memory (ROM) 422 is coupled to system bus 433 and may include a basic input/output system (BIOS), which controls certain basic functions of the processing system 400.

Further depicted are an input/output (I/O) adapter 427 and a communications/network adapter 426 coupled to the system bus 433. I/O adapter 427 may be a small computer system interface (SCSI) adapter that communicates with a hard disk 423 and/or a storage device 425 or any other similar component. I/O adapter 427, hard disk 423, and storage device 425 are collectively referred to herein as mass storage 434. Operating system 440 for execution on processing system 400 may be stored in mass storage 434. The communications/network adapter 426 interconnects system bus 433 with an outside network 436 enabling the processing system 400 to communicate with other such systems.

A display (e.g., a display monitor) 435 is connected to the system bus 433 by display adapter 432, which may include a graphics adapter to improve the performance of graphics intensive applications and a video controller. In one aspect of the present disclosure, adapters 426, 427, and/or 432 may be connected to one or more I/O busses that are connected to the system bus 433 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 433 via user interface adapter 428 and display adapter 432. An input device 429 (e.g., a keyboard, a microphone, a touchscreen, etc.), an input pointer 430 (e.g., a mouse, trackpad, touchscreen, etc.), and/or a speaker 431 may be interconnected to system bus 433 via user interface adapter 428, which may include, for example, a Super I/O chip integrating multiple device adapters into a single integrated circuit. One or more of the cameras 120-123,130-133 are also connected to the system bus 433.

In some aspects of the present disclosure, the processing system 400 includes a graphics processing unit 441. Graphics processing unit 441 is a specialized electronic circuit designed to manipulate and alter memory to accelerate the creation of images in a frame buffer intended for output to a display. In general, graphics processing unit 441 is very efficient at manipulating computer graphics and image processing and has a highly parallel structure that makes it more effective than general-purpose CPUs for algorithms where processing of large blocks of data is done in parallel.

Thus, as configured herein, the processing system 400 includes processing capability in the form of processors 421, storage capability including system memory (e.g., RAM 424), and mass storage 434, input means such as keyboard 429 and mouse 430, and output capability including speaker 431 and display 435. In some aspects of the present disclosure, a portion of system memory (e.g., RAM 424) and mass storage 434 collectively store the operating system 440 to coordinate the functions of the various components shown in the processing system 400.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The term “about” is intended. to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. it will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the above disclosure has been described with reference to exemplary embodiments, it will he understood by those skilled in the art that, various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A computer-implemented method for personalizing security features in a vehicle, comprising:
detecting, by a processor, a person in a cabin of the vehicle;
detecting, by a processor, an adjustable vehicle setting in relation to the person in the cabin of the vehicle;
comparing, by a processor, the adjustable vehicle setting to a stored adjustable vehicle setting in a first user profile; and
enabling, by the processor, operation of the vehicle based on the comparison and a permitted level of access from the first user profile.

2. The method of claim 1, wherein the adjustable vehicle setting includes one of a seat setting, a rear-view mirror setting, or a side-view mirror setting.

3. The method of claim 1, further comprising:
receiving, from a sensor, a first characteristic identifying a person approaching the vehicle;
comparing the first characteristic to a first stored characteristic in a second user profile; and
determining a permitted level of access of the person approaching the vehicle based on the comparison of the first characteristic and the first stored characteristic.

4. The method of claim 3, wherein when the comparison of the first characteristic and the first stored characteristic determines that the person approaching the vehicle is not identified by the second user profile, the method further comprises:
requesting the person approaching the vehicle provide a second characteristic;
comparing the second characteristic to a second stored characteristic in the second user profile; and
enabling access to the vehicle by the person approaching the vehicle based on the comparison of the second characteristic and the second stored characteristic.

5. The method of claim 3 further comprising:
detecting the vehicle accelerate at a rate greater than a threshold amount;
receiving an image of the person approaching the vehicle prior to the acceleration and comparing the image to images received from a law enforcement database; and
contacting law enforcement based on matching the image of the person accessing the vehicle to an image from the law enforcement database.

6. The method of claim 1 further comprising:
detecting an unauthorized person in the vehicle;
prompting a driver of the vehicle to park the vehicle within a predetermined time period; and
disabling the vehicle in the event that the driver continues to drive longer than the predetermined time period.

7. The method of claim 1 further comprising:
detecting an unauthorized person in the vehicle;
prompting a driver of the vehicle to park the vehicle within a predetermined time period; and
prompting the driver to answer a safety question upon detecting the vehicle parked within the predetermined time period.

8. A system for personalizing security features of a vehicle, comprising:
a memory having computer readable instructions; and
one or more processors for executing the computer readable instructions, the computer readable instructions controlling the one or more processors to perform operations comprising:
detecting a person in a cabin of the vehicle;
detecting an adjustable vehicle setting in relation to the person in the cabin of the vehicle;
comparing the adjustable vehicle setting to a stored adjustable vehicle setting in a first user profile; and
enabling operation of the vehicle based on the comparison and a permitted level of access from the first user profile.

9. The system of claim 8, wherein the adjustable vehicle setting includes one of a seat setting, a rear-view mirror setting, or a side-view mirror setting.

10. The system of claim 8, the operations further comprise:
receiving, from a sensor, a first characteristic identifying a person approaching the vehicle;
comparing the first characteristic to a first stored characteristic in a second user profile; and
determining a permitted level of access of the person approaching the vehicle based on the comparison of the first characteristic and the first stored characteristic.

11. The system of claim 10, wherein the comparison of the first characteristic and the first stored characteristic determines that the person approaching the vehicle is not identified by the second user profile, the operations further comprise:
requesting the person approaching the vehicle provide a second characteristic;
comparing the second characteristic to a second stored characteristic in the second user profile; and
enabling access to the vehicle by the person approaching the vehicle based on the comparison of the second characteristic and the second stored characteristic.

12. The system of claim 10, the operations further comprise:
detecting an unauthorized person in the vehicle;
detecting the vehicle accelerate at a rate greater than a threshold amount;
receiving an image of the person approaching the vehicle prior to the acceleration and comparing the image to images received from a law enforcement database; and
contacting law enforcement based on matching the image of the person accessing the vehicle to an image from the law enforcement database.

13. The system of claim 8, the operations further comprise:
detecting an unauthorized person in the vehicle;
prompting a driver of the vehicle to park the vehicle within a predetermined time period; and
disabling the vehicle in the event that the driver continues to drive longer than the predetermined time period.

14. The system of claim 8, the operations further comprise:
detecting an unauthorized person in the vehicle;
prompting a driver of the vehicle to park the vehicle within a predetermined time period; and
prompting the driver to answer a safety question upon detecting the vehicle parked within the predetermined time period.

15. A computer program product for personalizing security features of a vehicle, comprising a computer readable storage medium having program instructions embodied therein, the program instructions executable by a processor to cause the processor to perform operations comprising:
detecting a person in a cabin of a vehicle;
detecting an adjustable vehicle setting in relation to the person in the cabin of the vehicle;
comparing the adjustable vehicle setting to a stored adjustable vehicle setting in a first user profile; and
enabling operation of the vehicle based on the comparison and a permitted level of access from the first user profile.

16. The computer program product of claim 15, wherein the adjustable vehicle setting includes one of a seat setting, a rear-view mirror setting, or a side-view mirror setting.

17. The computer program product of claim 15, the operations further comprising:
receiving, from a sensor, a first characteristic identifying a person approaching the vehicle;
comparing the first characteristic to a first stored characteristic in a second user profile; and
determining a permitted level of access of the person approaching the vehicle based on the comparison of the first characteristic and the first stored characteristic.

18. The computer program product of claim 17, wherein the comparison of the first characteristic and the first stored characteristic determines that the person approaching the vehicle is not identified by the second user profile, the operations further comprise:
requesting the person approaching the vehicle provide a second characteristic;
comparing the second characteristic to a second stored characteristic in the second user profile; and
enabling access to the vehicle by the person approaching the vehicle based on the comparison of the second characteristic and the second stored characteristic.

19. The computer program product of claim 17, the operations further comprise:
detecting the vehicle accelerate at a rate greater than a threshold amount;
receiving an image of the person approaching the vehicle prior to acceleration and comparing the image to images received from a law enforcement database; and
contacting law enforcement based on matching the image of the person accessing the vehicle to an image from the law enforcement database.

20. The computer program product of claim 15, the operations further comprise:
detecting an unauthorized person in the vehicle;
prompting a driver of the vehicle to park the vehicle within a predetermined time period; and
disabling the vehicle in the event that the driver continues to drive longer than the predetermined time period.
